(19) United States
(12) Patent Application Publication
(10) Pub. No.: US 2011/0165451 A1
(43) Pub. Date: Jul. 7, 2011

(54) BATTERY PACK

(76) Inventors: Myung-Chul Kim, Yongin-si (KR); Tae-Yong Kim, Yongin-si (KR); Hyun-Ye Lee, Yongin-si (KR); Shi-Dong Park, Yongin-si (KR)

(21) Appl. No.: 12/796,911

(22) Filed: Jun. 9, 2010

Related U.S. Application Data
(60) Provisional application No. 61/292,457, filed on Jan. 5, 2010.

(51) Int. Cl. H01M 10/02

(52) U.S. Cl. 429/153

(57) ABSTRACT

A battery pack includes a plurality of battery modules, each of the battery modules having a plurality of secondary batteries stacked together and a housing assembly housing the secondary batteries; and a reinforcement assembly including at least one reinforcement plate extending around the housing assembly of at least one of the battery modules.

### CROSS-REFERENCE TO RELATED APPLICATIONS

This application claims the benefit of U.S. Provisional Application No. 61/292,457, filed on Jan. 5, 2010, in the United States Patent and Trademark Office, the disclosure of which is incorporated herein in its entirety by reference.

### BACKGROUND

1. Field

Embodiments of the present invention relate to a battery pack, and more particularly, to a battery pack formed by stacking battery modules each including a plurality of secondary batteries.

2. Description of the Related Art

As the number of gasoline vehicles has increased, the amount of vehicle exhaust emission has also increased. Vehicle exhaust emissions include large amounts of harmful substances, such as nitrogen oxide due to combustion, carbon monoxide or hydrocarbon due to imperfect combustion, and the like, and is recognized as a serious environmental pollution problem. As fossil fuels are anticipated to be exhausted in the not too distant future, development of next generation energy sources and hybrid electric vehicles have become important issues. In terms of commercializing hybrid electric vehicles, mileage of such vehicles is determined by battery performance. In general, (conventional) batteries do not have enough electrical energy for powering hybrid electric vehicles for a satisfactory period of time or mileage. If vehicles use any additional energy source such as gasoline, light oil, gas, or the like, the vehicles may quickly refuel at filling stations or gas charging stations. However, even when an electric charging station is available, it takes a long time to charge a hybrid electric vehicle, which is an obstacle to commercialization. Thus, with regard to hybrid electric vehicles, improving battery performance, compared to improving other technologies regarding hybrid electric vehicles, is recognized as an important goal.

For this reason, secondary batteries capable of charging and discharging have attracted much attention. Secondary batteries are widely used in high-tech electronic devices, such as cellular phones, notebook computers, camcorders, etc., and are also used as vehicle batteries.

Secondary batteries include an electrode assembly and an electrolyte. An electrode assembly in a secondary battery includes a negative plate, a positive plate, and a separator. The electrolyte includes lithium ions. The negative plate and the positive plate may each include an electrode tab that extends away from the assembly.

The electrode assembly may be accommodated in a case, and an electrode terminal may be exposed outside of the case. The electrode tabs may extend out of the electrode assembly to be electrically connected to the electrode terminal. The case may have a cylindrical or quadrangle shape.

### SUMMARY

Embodiments of the present invention include a battery pack, and more particularly, a battery pack formed by vertically or laterally stacking battery modules each including a plurality of secondary batteries.

According to one embodiment of the present invention, a battery pack is provided including a plurality of battery modules, each of the battery modules having a plurality of secondary batteries stacked together and a housing assembly housing the secondary batteries; and a reinforcement assembly including at least one reinforcement plate extending around the housing assembly of at least one of the battery modules.

In one embodiment, at least one reinforcement plate of a first one of the battery modules and at least one reinforcement plate of a second one of the battery modules are coupled to each other. Additionally, the battery pack may include at least one connection bracket coupled to at least one reinforcement plate of a first one of the battery modules and to at least one reinforcement plate of a second one of the battery modules, such as by welding. Further, one of the reinforcement plates of a first one of the battery modules may be spaced from one of the reinforcement plates of a second one of the battery modules by the connection bracket.

In one embodiment, each of the reinforcement plates has at least one connector extending therefrom, and such connector may be threaded and extend from one of the reinforcement plates in a direction away from the secondary batteries. Further, the connector of a reinforcement plate of a first one of the battery modules is not necessarily co-linear with an adjacent connector of the at least one reinforcement plate of a second one of the battery modules.

In one embodiment, at least one connection bracket is coupled to at least one connector of the at least one reinforcement plate of a first one of the battery modules and at least one connector of the at least one reinforcement plate of a second one of the battery modules. Additionally, each of the connection brackets may have a plurality of openings, each of the openings configured to receive one of the connectors.

In one embodiment, each of the at least one reinforcement plate extends entirely along a perimeter of the housing assembly of one of the battery modules. In another embodiment, each of the at least one reinforcement plate extends entirely along a perimeter of the battery pack.

In one embodiment, the housing assembly includes a first plate and a second plate extending along a first side and a second side, respectively, of the secondary batteries, wherein any one of the first and second plates has a groove configured to receive one of the at least one reinforcement plate. Further, the housing assembly may further include a third plate extending along a third side of the secondary batteries, wherein the third plate has a groove configured to receive one of the at least one reinforcement plate. Additionally, each of the secondary batteries may have an electrode terminal covered with an electrode terminal cover electrically insulating the electrode terminal from the at least one reinforcement plate.

In one embodiment, a battery pack includes a plurality of battery modules, each of the battery modules having a plurality of secondary batteries stacked together and a housing assembly housing the secondary batteries; and a connection bracket directly coupled to a first one and a second one of the battery modules to fix the first one and the second one of the battery modules together. Further, the battery pack may further include a plurality of reinforcement plates on the battery modules, wherein the connection bracket is coupled to the reinforcement plates and/or to the housing assembly to fix the first one and the second one of the battery modules together.

### BRIEF DESCRIPTION OF THE DRAWINGS

These and/or other aspects will become apparent and more readily appreciated from the following description of the embodiments, taken in conjunction with the accompanying drawings of which:

FIG. 1 is a schematic partially exploded perspective view of a battery pack formed by stacking a plurality of battery modules according to an embodiment of the present invention;

FIG. 2 is a schematic perspective view of the battery pack of FIG. 1 in which the battery modules of FIG. 1 are attached to one another by a first connection bracket);

FIG. 3 is a partially exploded perspective view of an exemplary one of the battery modules of FIG. 1;

FIG. 4 is a schematic front view of the battery pack of FIG. 2;

FIG. 5 is an exploded perspective view of a battery module according to another embodiment of the present invention;

FIG. 6 is a schematic front view of a battery pack formed by stacking a plurality of the battery modules of FIG. 5;

FIG. 7 is a perspective view of another embodiment of the first connection bracket of the battery pack of FIG. 2;

FIG. 8 is a schematic front view of the battery pack of FIG. 7;

FIG. 9 is a partially exploded perspective view of a battery module according to another embodiment of the present invention;

FIG. 10 is a schematic perspective view of a side plate in which side grooves are formed, according to an embodiment of the present invention;

FIG. 11 is a schematic perspective view of the battery pack of FIG. 1 arranged in a plurality of rows; and

FIG. 12 is a schematic front view of the battery packs of FIG. 11.

FIG. 13 is a schematic perspective view of another embodiment of a battery pack of the present invention.

FIG. 14 is a schematic perspective view of yet another embodiment of a battery pack of the present invention.

FIG. 15 is a schematic perspective view of still another embodiment of a battery pack of the present invention.

### DETAILED DESCRIPTION

Reference will now be made in detail to embodiments, examples of which are illustrated in the accompanying drawings.

A battery pack according to an embodiment of the present invention may be formed by stacking a plurality of battery modules vertically and/or laterally. Each of the battery modules may be formed by stacking a plurality of secondary batteries vertically and/or laterally. Without any additional support, the battery modules may deflect due to the weight of the plurality of secondary batteries. Also, the battery modules may vibrate due to the deflection.

First, a battery pack 300 will be described. The battery pack 300 may include a plurality of battery modules 1. Each of the battery modules 1 may be formed by arranging a plurality of secondary batteries 10 in a predetermined direction and electrically connecting the secondary batteries 10 to each other. Each of the secondary batteries 10 may be a lithium secondary battery. For example, each battery module 1 may include twelve secondary batteries 10, and the battery pack 300 may include eight battery modules 1 stacked in four layers. However, the numbers of secondary batteries 10 and battery modules 1 are not limited thereto, and one of ordinary skill in the art would understand that various other configurations are possible. When the plurality of battery modules 1 are stacked to form the battery pack 300, the battery modules 1 are connected to one another to increase structural stability of the battery pack 300.

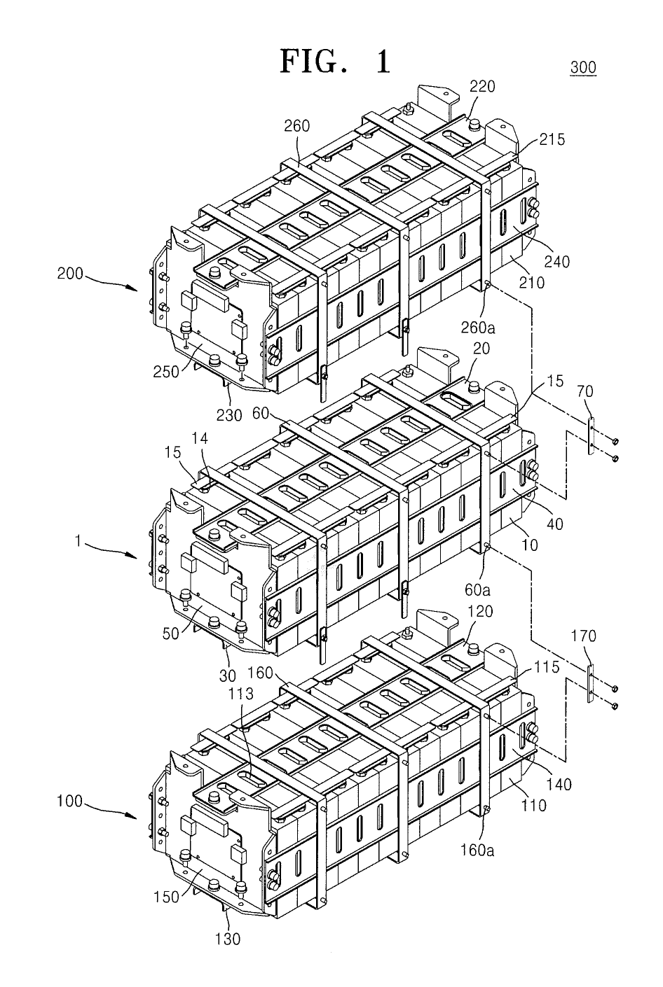

Accordingly, the battery pack 300 including reinforcement plates 60, 160, and 260 for increasing structural coherence among the battery modules 1 will now be described with reference to FIGS. 1 through 4.

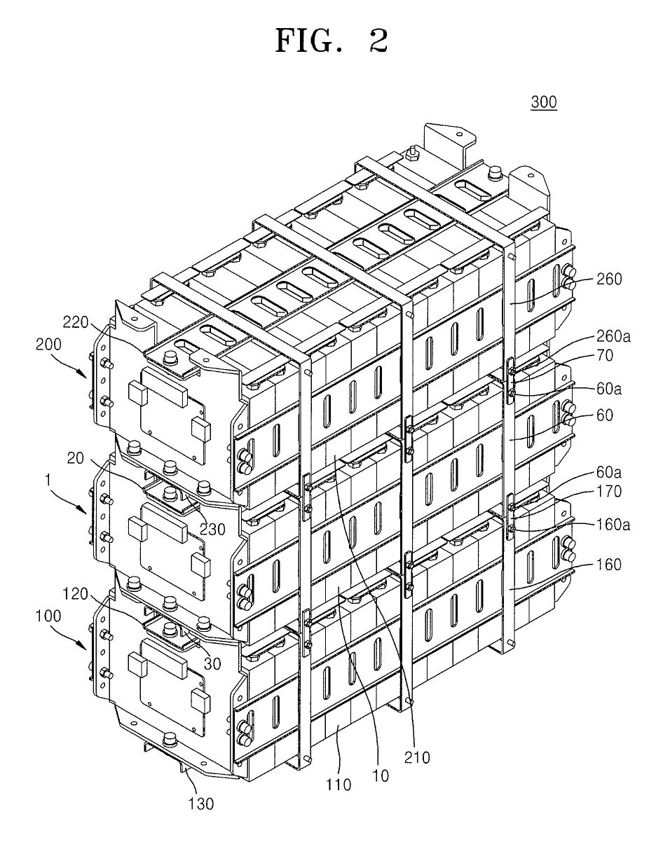

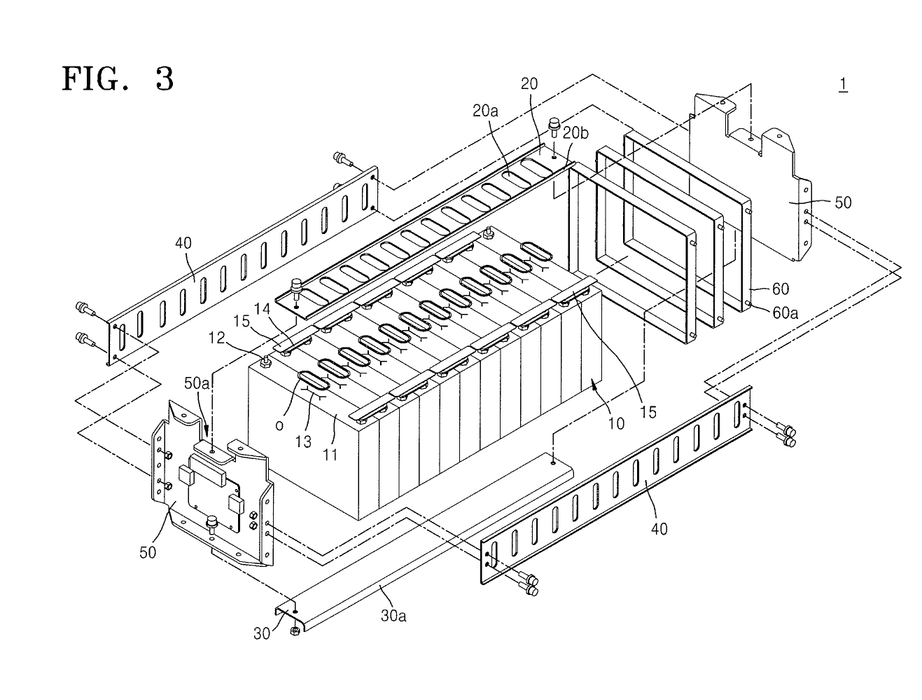

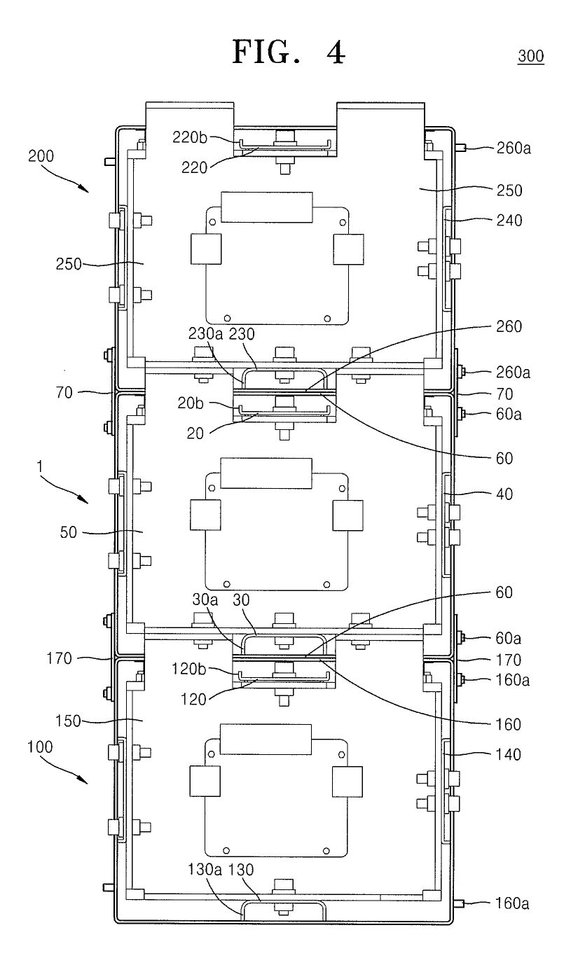

FIG. 1 is a schematic partially exploded perspective view of the battery pack 300 formed by stacking the battery module 1, a battery module 100, and a battery module 200, wherein descriptions of the battery module 1 may be applied to the battery modules 100 and 200, according to an embodiment of the present invention. FIG. 2 is a schematic perspective view of the battery pack 300 of FIG. 1 including the battery modules 1, 100, and 200 attached to one another. FIG. 3 is a partially exploded perspective view of the battery module 1 according to an embodiment of the present invention. FIG. 4 is a schematic front view of the battery modules 1, 100, and 200 of FIG. 2.

The battery pack 300 is formed by stacking the battery modules 1, 100, and 200. Referring to FIG. 3, the battery module 1 includes a plurality of the secondary batteries 10, a top plate 20, a bottom plate 30, side plates 40, and end plates 50.

Referring to an exemplary one of the secondary batteries 10 in the battery module 1, the secondary battery 10 includes an electrode assembly, a case 11, and electrode terminals 12. The electrode assembly includes a negative electrode, a separator, and a positive electrode, and may be a winding type or a stack type assembly. The case 11 accommodates the electrode assembly. The electrode terminals 12 may protrude from the case 11 and electrically connect the secondary battery 10 with an external device. The case 11 may include a vent 13. The secondary battery 10 may be perforated so as to rupture at a predetermined internal pressure. Accordingly, the vent 13 may be formed relatively weakly so that gas generated in the case 11 may be emitted through the perforated vent 13. A cap plate may be coupled with an opening of the case 11. The cap plate may be a thin plate and may include an electrolyte inlet through which an electrolyte is injected. After the electrolyte is injected through the electrolyte inlet, the electrolyte inlet may be sealed with a sealing cover.

The secondary batteries 10 (of the battery module 1 of FIG. 3) may be arranged facing one another in a predetermined direction. The secondary batteries 10 may be electrically connected in parallel, in series, or in a series and parallel combination. To connect the secondary batteries 10 in parallel or series, negative plates and positive plates of the secondary batteries 10 may be alternately arranged. The electrode terminals 12 of the secondary batteries 10 may be connected to each other by a bus bar 14.

As illustrated in FIG. 1, the secondary batteries 10 may be general quadrangle secondary batteries. However, the present invention is not limited thereto, and the secondary batteries 10 may be any of various battery cells, such as circular secondary batteries or pouch-type secondary batteries. A connection structure and the number of stacked secondary batteries 10 may be determined taking into consideration the charging and discharging capacities required when the battery pack 300 is designed.

Referring again to one secondary battery 10 of the battery module 1, the electrode assembly of the secondary battery 10, which may contain lithium, expands or contracts due to charging or discharging. The expansion or contraction of the electrode assembly exerts a physical force on the case 11, and thus the case 11 expands or contracts according to the expansion or contraction of the electrode assembly. The changes of the case 11 may be permanent by repeated expansions and contractions, and the expansion increases resistance, thereby decreasing efficiency of the secondary battery 10. Accordingly, with respect to the battery module 1, the one pair of end plates 50 thereof may be arranged in a predetermined direction to be respectively disposed at either end portion of the secondary batteries 10 which are electrically connected to one another. The side plate 40 is connected to a side portion of the end plates 50 to compress and fix the secondary batteries 10 so that expansion or contraction in a lengthwise direction of the secondary batteries 10 may be prevented or significantly reduced.

The top plate 20 is disposed on the plurality of secondary batteries 10 and is connected to an upper portion of the end plates 50. Openings 20a formed in the top plate 20 correspond to the vents 13 of the secondary batteries 10. The top plate 20 may include top plate bended portions 20b formed on both longitudinal sides of the top plate 20 in such a way that the top plate bended portions 20b protrude upwards away from the battery module 1 and give the top plate 20 generally a “U” shape. Each of the openings 20a formed in the top plate 20 may include a sealing ring O between the top plate 20 and the corresponding vent 13, so that when gas is emitted from one of the vents 13, the gas does not affect a secondary battery adjacent thereto. The sealing ring O may be an O-shaped ring. A groove 50a is formed in an upper center portion of the end plates 50 to accommodate the top plate 20. The openings 20a of the top plate 20 may be disposed in close proximity to the secondary batteries 10.

With reference to the battery module 1, the bottom plate 30 is located under the secondary batteries 10 to support the weight of the plurality of secondary batteries 10, and is connected to a lower portion of the end plates 50. In order to accommodate the weight of the secondary batteries 10, the bottom plate 30 may include bottom plate bended portions 30a. The bottom plate bended portions 30a may be formed on both longitudinal sides of the bottom plate 30 in such a way that the bottom plate bended portions 30a protrude downwards away from the battery module.

The battery module 1 may be coupled to and supported by an adjacent battery module via the end plates 50, and thus the battery pack 300 may be formed by vertically and/or laterally stacking, for example, the battery modules 1, 100, and 200.

The reinforcement plates 60 structurally may connect the battery module 1 to another battery module. The reinforcement plates 60 may have various shapes, for example, a rectangular shape to surround the battery module 1, as illustrated in FIG. 3. The electrode terminals 12 of the secondary batteries 10 of the battery module 1 are covered with an electrode terminal cover 15 so that the reinforcement plates 60 do not contact the electrode terminals 12 to thereby cause a short-circuit. In FIG. 3, the reinforcement plates 60 may support the battery module 1 by surrounding the top plate 20, the side plate 40, and the bottom plate 30. The reinforcement plates 60 included in the battery module 1 are connected with the reinforcement plates 160 and 260 of the adjacent battery modules 100 and 200 to maintain the structure of the stacked battery modules 1, 100, and 200. In FIGS. 1 through 3, the battery modules 1, 100, and 200 include the reinforcement plates 60, 160, and 260, respectively. However, the numbers of reinforcement plates 60, 160, and 260 that may be used respectively in each of the battery modules 1, 100, and 200 are not limited to as illustrated, and different numbers of reinforcement plates 60, 160, and 260 may be disposed.

The reinforcement plates 60, 160, and 260 will now be described with reference to FIGS. 1, 2 and 4. The battery pack 300 may be formed by stacking the battery modules 1, 100, and 200. The stackable number of battery modules 1, 100, and 200 is not limited to as illustrated. However, for convenience of description, in FIG. 1, the battery modules 1, 100, and 200 are stacked in a triple-layered structure. Referring to FIGS. 1, 2 and 4, a battery module disposed under the battery module 1 (the second battery module 100) is substantially similar to the battery module 1. A battery module disposed above the battery module 1 may be the third battery module 200. In order to clarify location relations among the battery modules 1, 100, and 200, each battery module may be respectively referred to as the first battery module 1, the second battery module 100, and the third battery module 200, but components of the first, second, and third battery modules 1, 100, and 200 may be same. The reinforcement plates 60 of the first battery module 1 may include connectors (or connectors) 60a to be easily connected to the reinforcement plates 160 and 260 of the second and third battery modules 100 and 200, which are adjacent to the first battery module 1. That is, the reinforcement plates 160 and 260 of the second and third battery modules 100 and 200, which are adjacent to the reinforcement plate 60 of the first battery module 1, may be screw-coupled to the reinforcement plate 60 of the first battery module 1 via first connection brackets (or connection brackets) 70 and 170 through the connectors 60a, connectors 160a, and connectors 260a. The connectors 60a, 160a, and 260a and the first connection brackets 70 and 170 may be screw-coupled with one another. However, the coupling among the reinforcement plates 60, 160, and 260 is not limited to screw-coupling, and any of various coupling methods, for example, welding, may be used. As such, the second battery module 100 and the third battery module 200 adjacent to the first battery module 1 are coupled through the first connection brackets 70 and 170, and thus the entire stability of the battery pack 300 may be increased. Also, the reinforcement plates 60, 160, and 260 are structurally connected to not only the bottom plate 30, a bottom plate 130, and a bottom plate 230, but also the top plate 20, a top plate 120, and a top plate 220, and the side plate 40, a side plate 140 and a side plate 240. Accordingly, the reinforcement plates 60, 160, and 260 structurally disperse loads of the secondary batteries 10, 110 and 210 to prevent deflection of the battery modules 1, 100, and 200.

The top plate bended portions 20b, 120b, 220b or/and the bottom plate bended portion 30a, 130a, 230a of the bottom plates 30, 130, and 230 may be formed to have heights less than a predetermined value. Referring to FIG. 4, when the top plate bended portions 20b, 120b, and 220b of the top plates 20, 120, and 220 and the bottom plate bended portion 30a, 130a, 230a of the bottom plates 30, 130, and 230 face and contact one another, the reinforcement plates 60, 160, and 260 are difficult to be inserted above the top plates 20, 120, and 220 or under the bottom plates 30, 130, and 230. Accordingly, the top plate bended portions 20b, 120b, and 220b of the top plates 20, 120, and 220 are formed to have heights less than a predetermined value, so that the reinforcement plates 60, 160, and 260 may be located above the top plates 20, 120, and 220. Also, the bottom plate bended portions 30a, 130a, and 230a of the bottom plates 30, 130, and 230 are formed to have heights less than a predetermined value, so that the reinforcement plates 60, 160, and 260 may be located under the bottom plates 30, 130, and 230. In this instance, either the top plate bended portions 20b, 120b, and 220b or the bottom plate bended portions 30a, 130a, and 230a, or both, may be formed to have heights less than a predetermined value.

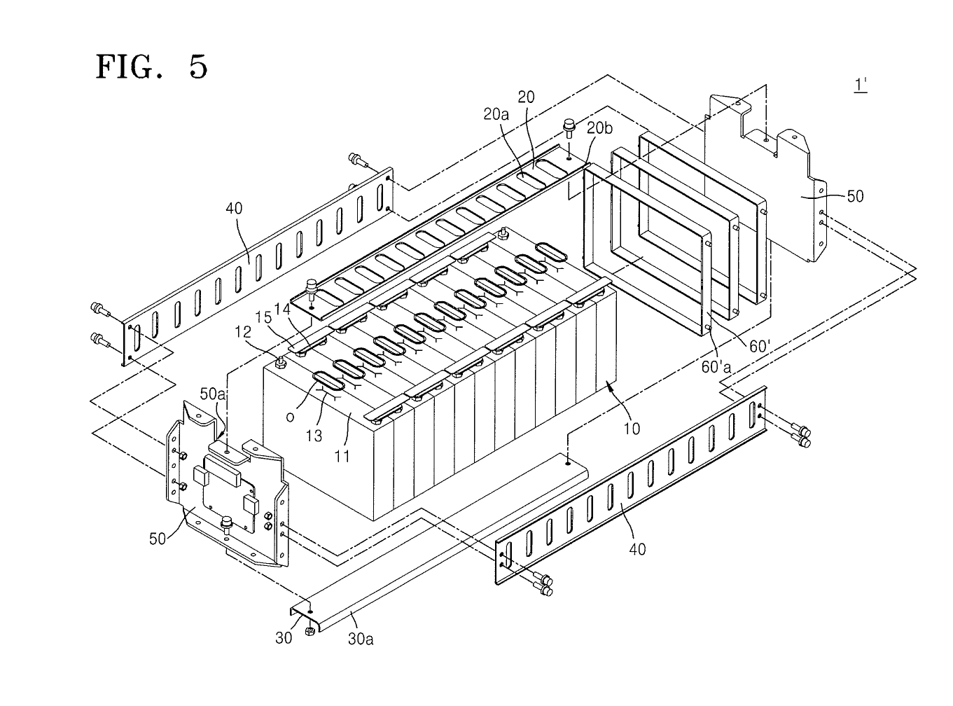

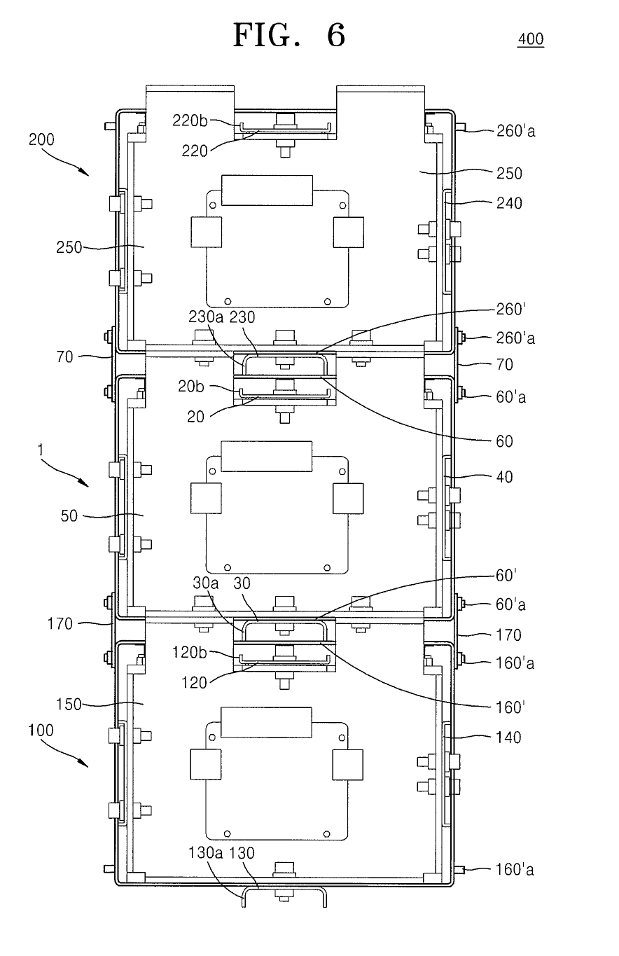

In this instance, it is not necessary for the reinforcement plates 60 to surround the entire periphery of the battery module 1, that is, the battery module 1 including the top plate 20, the bottom plate 30, and the side plate 40, as illustrated in FIGS. 1 through 4. For example, referring to FIGS. 5 and 6, the reinforcement plates 60 may be formed to pass through between the top plate 20 and the side plate 40 and between the secondary battery 10 and the bottom plate 30.

FIG. 5 is a partially exploded perspective view of a battery module 1′ according to another embodiment of the present invention. FIG. 6 is a schematic front view of a battery pack 400 formed by stacking the battery module 1′ of FIG. 5 a plurality of times. The reinforcement plates 60 may be disposed between the bottom plate 30 and the secondary batteries 10 thereof. As such, when the reinforcement plates 60 are disposed between the bottom plate 30 and the secondary batteries 10, it is not necessary for the reinforcement plates 60 to be formed passing through below the reinforcement plates 60. Although not shown in the drawings, the reinforcement plates 60 may pass through between the top plate 20 and the secondary batteries 10 and between the bottom plate 30 and the secondary batteries 10. When the reinforcement plates 60 are located as described above, coupling between the bottom plate 30 of the first battery module 1′ and the top plate 120 of the second battery module 100 may not be hindered. Therefore, the reinforcement plates 60 are not limited to being oriented to surround an entire periphery of the top plate 20, the bottom plate 30, and the side plate 40, and may be located in the inner part of any one of the top plate 20, the bottom plate 30, and the side plate 40.

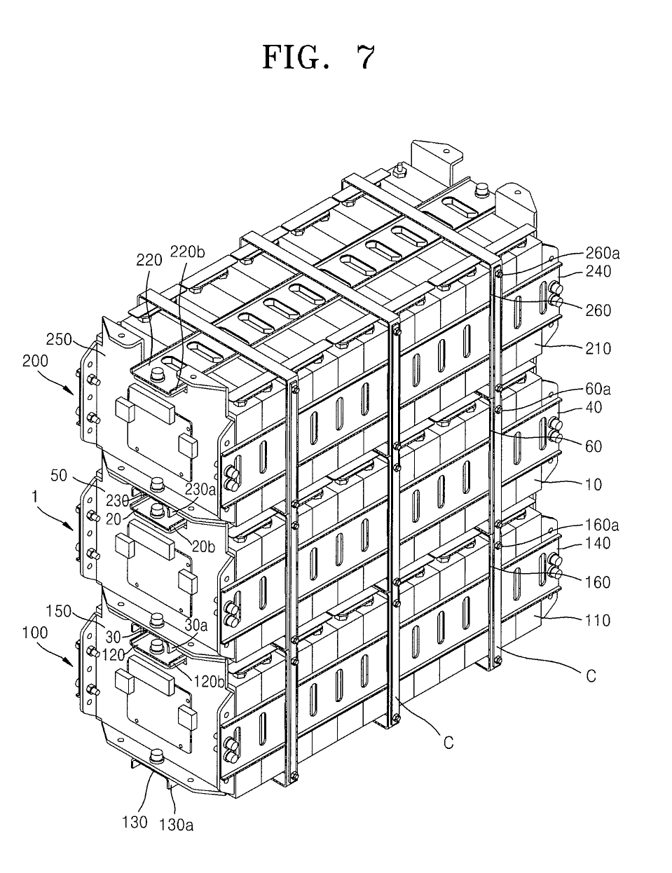

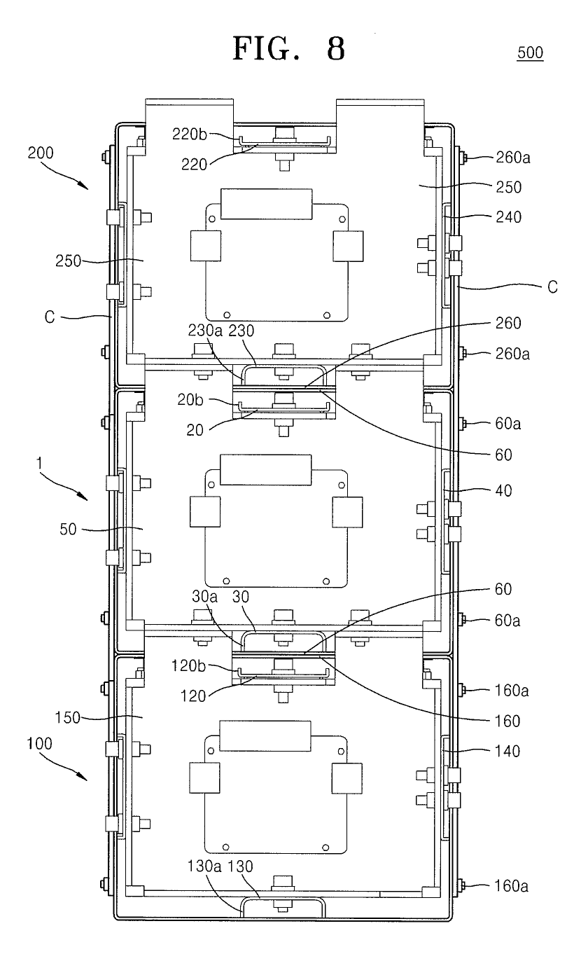

Also, the reinforcement plates 60, 160, and 260 may be coupled to one another using various coupling methods. For example, referring to FIG. 7 or 8, the reinforcement plates 60, 160, and 260 respectively disposed in the battery modules 1, 100, and 200 may be coupled to a connecting plate C to maintain each structure of the battery modules 1, 100, and 200. The connecting plate C may be formed of an integral plate. Accordingly, when a single connecting plate C is used, a structural stability of the battery pack may be increased, compared to when a plurality of first connection brackets 70, 170, and 270 are used. The reinforcement plates 60, 160, and 260 and the connecting plate C may be coupled through screw-coupling between the connectors 60a, 160a, and 260a of the reinforcement plates 60, 160, and 260 and the connecting plate C or through welding between the reinforcement plates 60, 160, and 260 and the connecting plate C.

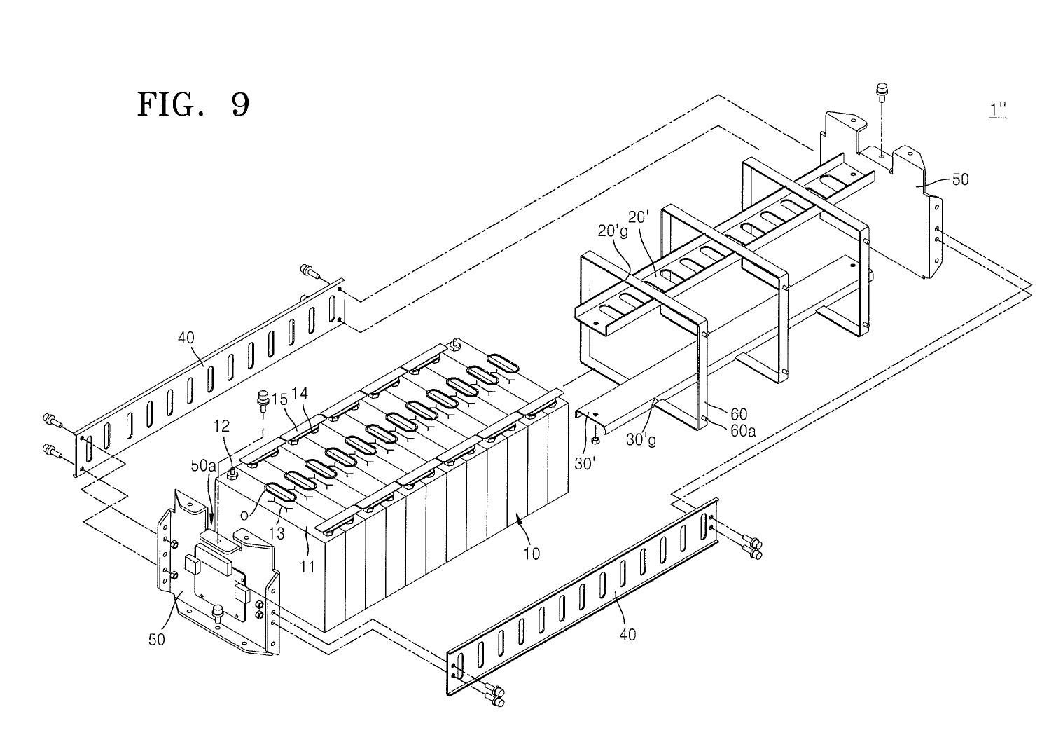

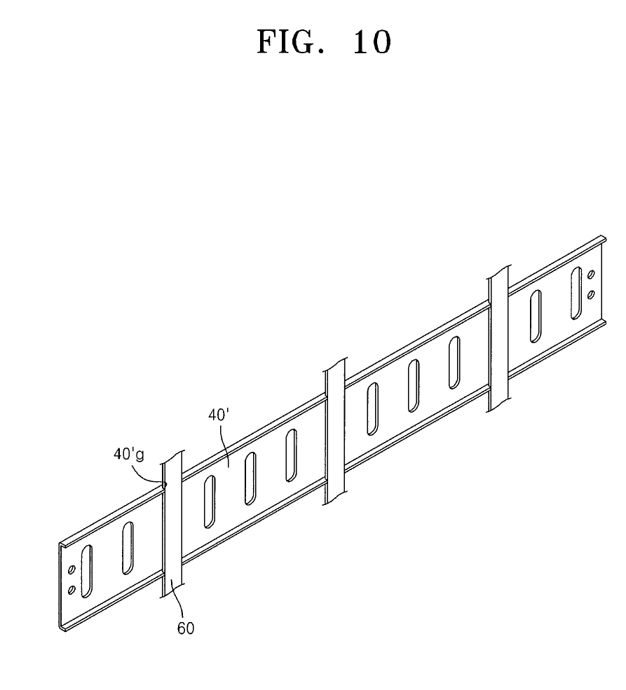

In this instance, in order to facilitate coupling of the reinforcement plates 60, 160, and 260 and the connecting plate C, the components of battery modules 1, 100, and 200 may include grooves for minimizing space required for the reinforcement plates 60, 160, and 260, which will be described with reference to FIG. 9 or 10.

FIG. 9 is an exploded perspective view of a battery module 1″ according to another embodiment of the present invention. FIG. 10 is a schematic perspective view of a side plate 40′ in which side grooves 40′g are formed, according to an embodiment of the present invention.

Referring to FIG. 9, an upper groove 20′g may be formed in a top plate 20′ corresponding to the reinforcement plates 60. The reinforcement plates 60 are prevented from moving due to the upper groove 20′g formed in the top plate 20′, and enter into the upper groove 20′g according to the depth of the upper groove 20′g, and thus the space required for the reinforcement plate 60 may be reduced. Alternatively, reinforcement plate 60 may be prevented from moving by a lower groove 30′g formed in a bottom plate 30′, and enter into the lower groove 30′g, and thus the space required for the reinforcement plates 60 may be reduced. In this instance, a groove may be formed in at least one of the top plate 20′ or the bottom plate 30′, but the location of the groove is not limited thereto. For example, referring to FIG. 10, a side groove 40′g may be on a side plate 40′. In this instance, the reinforcement plates 60 enter into the side groove 40′g according to the depth of the side groove 40′g, and thus the space required for the reinforcement plates 60 may be reduced. The reinforcement plates 60 may be prevented from moving by being coupled with at least one of the upper groove 20′g, the lower groove 30′g, or the side groove 40′g, and thus the space required for the reinforcement plates 60 is minimized so that the reinforcement plates 60 do not hinder structural degrees of freedom of other components.

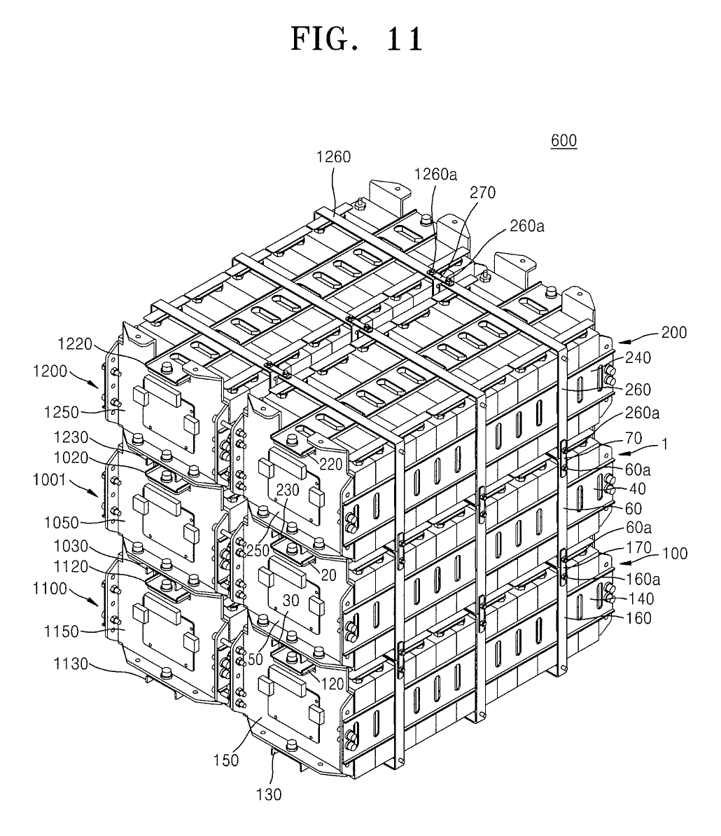

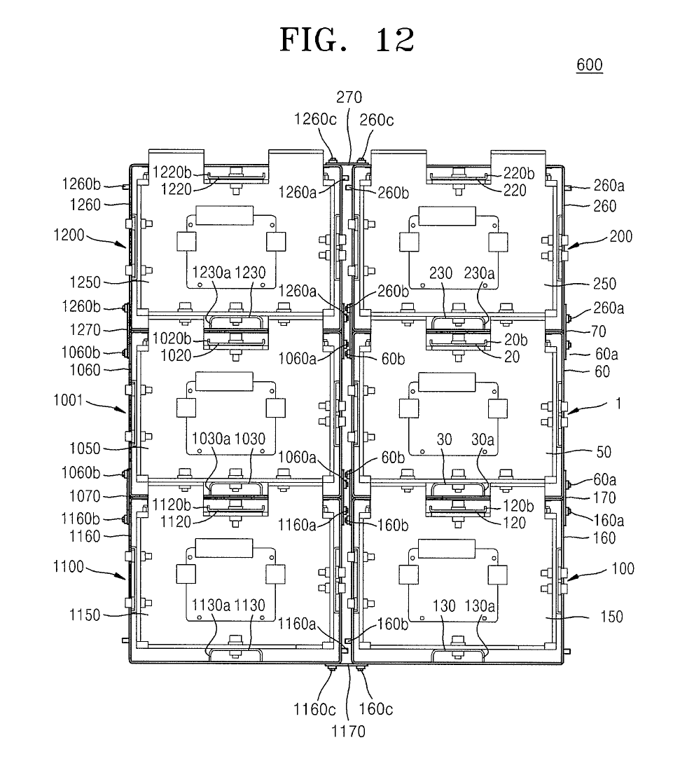

The stacking method of the battery modules 1, 100, and 200 and battery modules 1001, 1100, and 1200 is not limited thereto, and various methods may be used. Also, adjacent reinforcement plates 60, 160, and 260 and reinforcement plates 1060, 1160, and 1260 may be coupled with one another. For example, referring to FIGS. 11 and 12, the battery modules 1, 100, 200, 1001, 1100, and 1200 may be stacked in a plurality of rows.

FIG. 11 is a schematic perspective view of the battery pack of FIG. 1 arranged a plurality of times in a plurality of rows. FIG. 12 is a schematic front view of the battery packs of FIG. 11.

Each of the reinforcement plates 60, 160, 260, 1060, 1160, and 1260 of the battery modules 1, 100, 200, 1001, 1100, and 1200 may be screw-coupled to adjacent reinforcement plates through the first connection brackets 70, 170, 270, and first connection brackets 1070, and 1170.

Hereinafter, for convenience of description, each battery module will be referred to as the first battery module 1, the second battery module 100, the third battery module 200, a fourth battery module 1001, a fifth battery module 1100, and a sixth battery module 1200. The first connectors 60a and second connectors 60b of the first battery module 1 may not be oriented symmetrically about each other based on the centers of the end plates 50. Since the first connectors 60a and the second connectors 60b are not oriented symmetrically about each other, when the first battery module 1 is located adjacent to the fourth battery module 1001, the connectors do not hinder one another, thereby minimizing the volume required. That is, referring to FIG. 12, the second connectors 60b of the first battery module 1 and first connectors 1060a of the fourth battery module 1001 are oriented asymmetrically about each other. Accordingly, the second connectors 60b and the first connectors 1060a do not hinder each other, and thus the first battery module 1 and the fourth battery module 1001 may be located adjacent to each other.

The reinforcement plates 60, 160, 260, 1060, 1160, and 1260 may be coupled not only vertically, but also laterally. For example, the sixth battery module 1200 and the third battery module 200 are adjacent to each other and may be coupled to each other through a first connection bracket 270. The reinforcement plates 260 and 1260, which are respectively disposed in the uppermost part of the third and sixth battery modules 200 and 1200, may respectively include third connectors 260c and 1260c. The second battery module 100 and the fifth battery module 1100, which are respectively located in the lowermost part of the second and fifth battery modules 100 and 1100, may be coupled to each other. For example, a third connecting member 160c formed in the second battery module 100 and a third connecting member 1160c formed in the fifth battery module 1100 may be mechanically coupled to each other through the first connection bracket 1170.

As such, the reinforcement plates 60, 160, 260, 1060, 1160, and 1260 may be not only vertically coupled to one another, but also mechanically coupled to adjacent reinforcement plates. The coupling method is not limited to the screw-coupling as illustrated in FIG. 11 or 12. For example, the reinforcement plates 60, 160, 260, 1060, 1160, and 1260 may be coupled to one another through welding. Also, the coupling method is not limited to the coupling through the first connection brackets 70, 170, 270, 1070, 1170, and 1270. For example, as illustrated in FIG. 7 or 8, the battery modules 1, 100, 200, 1001, 1100, and 1200 oriented vertically may be coupled to one another through the integral connecting plate C, and also may be coupled by welding through the connecting plate C.

Although not shown in the drawing, the single connecting plate C may surround the plurality of battery modules 1, 100, 200, 1001, 1100, and 1200 and may couple them to one another through a screw-coupling method.

The battery pack 300 including the plurality of battery modules 1, 200, and 300 may be used in electric vehicles. If the battery pack 300 including the secondary battery 10 emits poisonous gas due to an explosion or other reasons, the poisonous gas is explosively emitted in a short period of time. When the poisonous gas flows into the vehicles, the gas affects the human body. In this instance, the battery pack 300 may be accommodated in a sealing case, and the sealing case may be externally connected. In order to avoid this risk, the battery pack 300 may have a structure for reducing vibration. In the battery pack 300 according to an embodiment of the present invention, the reinforcement plates 60 support parts where deflection is generated in the battery module 1, thereby reducing deflection and vibration of the battery module 1.

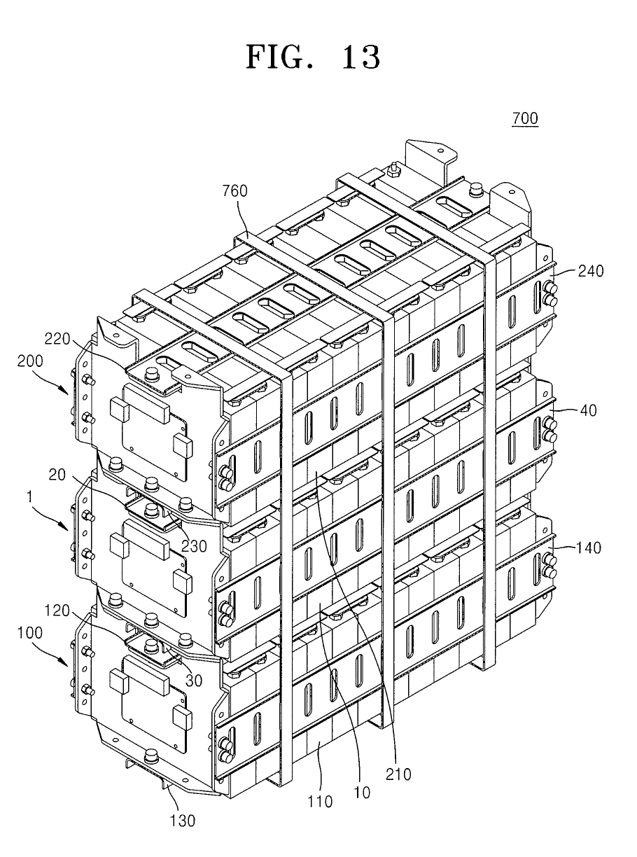

With reference now to FIG. 13, showing another embodiment of the present invention, a battery pack 700 includes the battery modules 1, 100, 200 as described above. Further, the battery pack 700 includes reinforcement plates 760 that extend around an entire periphery of the entire battery pack 700, rather than only a periphery of a battery module 1, 100, 200.

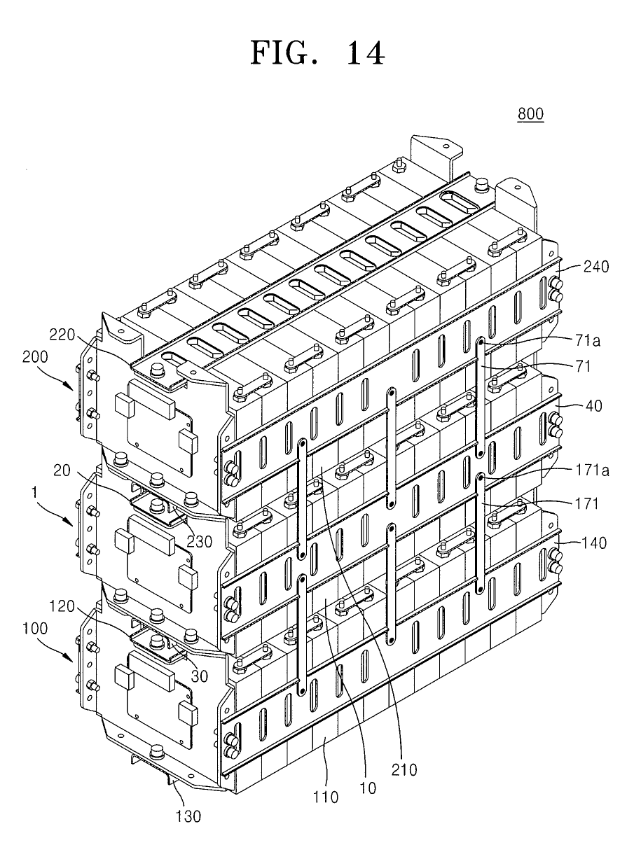

With reference now to FIG. 14, showing another embodiment of the present invention, a battery pack 800 includes the battery modules 1, 100, 200 as described above. Additionally, the battery pack 800 includes connection brackets 71, 171 coupled directly to the sides plates 40, 140, 240 of the battery modules 1, 100, 200. In one embodiment, each connection bracket 71, 171 is connected to two side plates 40, 140, 240, one each of adjacent battery modules 1, 100, 200, to couple the battery modules together. The connection brackets 71, 171 may be coupled to the side plates 40, 140, 240 at connection portions 71a, 171a, such as by welding or by a fastener, such as a nut and bolt.

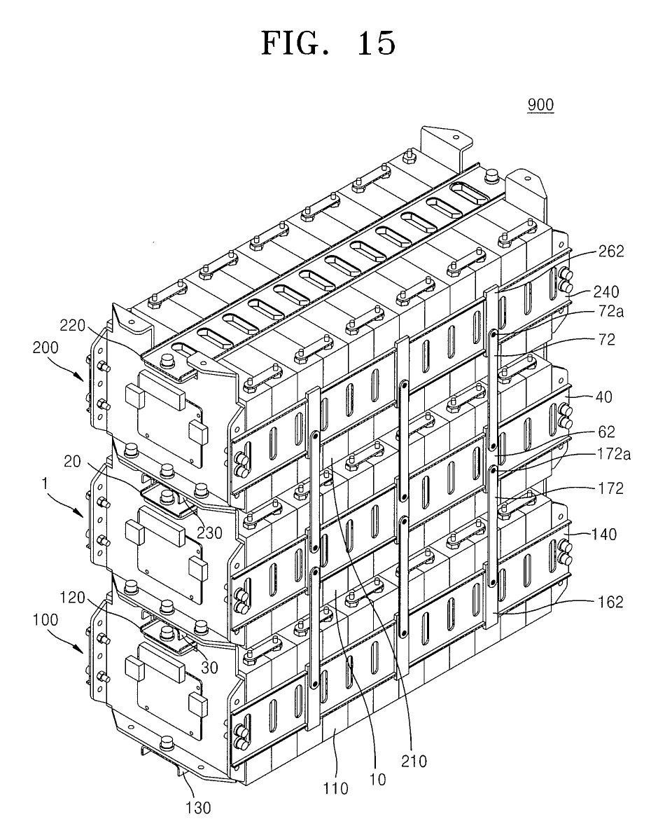

With reference now to FIG. 15, showing another embodiment of the present invention, a battery pack 900 includes the battery modules 1, 100, 200 as described above. The battery pack 900 further includes reinforcement plates 62, 162, 262 attached to a single side plate 40, 140, 240 and connection brackets 72, 172 directly attached to the reinforcement plates on side plates 40, 140, 240 of adjacent battery modules 1, 100, 200. The connection brackets 71, 171 may be coupled to the reinforcement plates 62, 162, 262 at connection portions 71a, 171a, such as by welding or by a fastener, such as a nut and bolt.

According to the present invention, a battery pack is formed by vertically or laterally stacking battery modules each including a plurality of secondary batteries, thereby reducing deflection and vibration of the battery modules.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A battery pack comprising:
a plurality of battery modules, each of the battery modules comprising a plurality of secondary batteries stacked together and a housing assembly housing the secondary batteries; and
a reinforcement assembly comprising at least one reinforcement plate extending around the housing assembly of at least one of the battery modules.

2. The battery pack of claim 1, wherein the at least one reinforcement plate of a first one of the battery modules and the at least one reinforcement plate of a second one of the battery modules are coupled to each other.

3. The battery pack of claim 1, further comprising at least one connection bracket coupled to the at least one reinforcement plate of a first one of the battery modules and to the at least one reinforcement plate of a second one of the battery modules.

4. The battery pack of claim 3, wherein the at least one connection bracket is coupled to the at least one reinforcement plate of the first one of the battery modules and to the at least one reinforcement plate of the second one of the battery modules by welding.

5. The battery pack of claim 4, wherein the one of the at least one reinforcement plate of the first one of the battery modules is spaced from the one of the at least one reinforcement plate of the second one of the battery modules by the connection bracket.

6. The battery pack of claim 1, wherein each of the at least one reinforcement plate has at least one connector extending therefrom.

7. The battery pack of claim 6, wherein each of the connectors has a threaded portion.

8. The battery pack of claim 6, wherein each of the at least one connector extends from one of the reinforcement plates in a direction away from the secondary batteries.

9. The battery pack of claim 6, wherein the at least one connector of the at least one reinforcement plate of a first one of the battery modules is not co-linear with an adjacent one of the at least one connector of the at least one reinforcement plate of a second one of the battery modules.

10. The battery pack of claim 6, further comprising at least one connection bracket coupled to one of the at least one connector of the at least one reinforcement plate of a first one of the battery modules and one of the at least one connector of the at least one reinforcement plate of a second one of the battery modules.

11. The battery pack of claim 10, wherein each of the at least one connection bracket has a plurality of openings, each of the openings configured to receive one of the connectors.

12. The battery pack of claim 10, wherein each of the at least one connection bracket is coupled to at least one additional reinforcement plate of the reinforcement plates.

13. The battery pack of claim 1, wherein each of the at least one reinforcement plate extends entirely along a perimeter of the housing assembly of one of the battery modules.

14. The battery pack of claim 1, wherein the housing assembly comprises a first plate and a second plate extending along a first side and a second side, respectively, of the secondary batteries, wherein any one of the first and second plates has a groove configured to receive one of the at least one reinforcement plate.

15. The battery pack of claim 14, wherein the housing assembly further comprises a third plate extending along a third side of the secondary batteries, wherein the third plate has a groove configured to receive one of the at least one reinforcement plate.

16. The battery pack of claim 1, wherein each of the secondary batteries has an electrode terminal covered with an electrode terminal cover electrically insulating the electrode terminal from the at least one reinforcement plate.

17. The battery pack of claim 1, wherein each of the at least one reinforcement plate has a substantially rectangular perimeter.

18. A battery pack comprising:
a plurality of battery modules each of the battery modules comprising a plurality of secondary batteries stacked together and a housing assembly housing the secondary batteries; and
a connection bracket coupled to a first one and a second one of the battery modules to fix the first one and the second one of the battery modules together.

19. The battery pack of claim 18, further comprising a plurality of reinforcement plates on the battery modules, wherein the connection bracket is coupled to the reinforcement plates to fix the first one and the second one of the battery modules together.

20. The battery pack of claim 18, wherein the connection bracket is coupled to the housing assembly of the first one and the second one of the battery modules.
